(19) United States
(12) Patent Application Publication
(10) Pub. No.: US 2025/0362895 A1
(43) Pub. Date: Nov. 27, 2025

(54) APPLICATION DEPLOYMENT

(71) Applicant: INTERNATIONAL BUSINESS MACHINES CORPORATION, Armonk, NY (US)

(72) Inventors: Dominic John Storey, Eastleigh (GB); Amar Shah, Pune (IN); Robert Convery, Fair Oak (GB)

(21) Appl. No.: 18/673,769

(22) Filed: May 24, 2024

(51) Int. Cl. G06F 8/60

(52) U.S. Cl. CPC G06F 8/60

(57) ABSTRACT

Methods, computer program products, and systems are presented. The method computer program products, and systems can include, for instance: examining application configuration data defining a configured software application and integration runtime engine profile data that specifies attributes of a plurality of integration runtime engines currently running within a computer environment; evaluating, in dependence on the examining, a suitability of respective ones of the plurality of the integration runtime engines for supporting running of the configured software application; returning an action decision in dependence on the evaluating, wherein the action decision specifies a selected integration runtime engine for supporting running of the configured software application; and deploying the configured software application to the selected integration runtime engine.

### BACKGROUND

Embodiments herein relate to virtual machine workloads generally, and particularly to merging of virtual machine workloads.

There are a plurality of cloud based computer environment providers on the market today, each of them offering specific services with service levels, targeting specific use cases, groups of clients, vertical and geographic markets. These cloud providers compete with services of traditional IT service providers which are operated typically in on-premise environments of client owned datacenters. While cloud providers seem to have advantages over said company-owned datacenters, they are not under direct control of the client companies and there is a substantial risk of failure to provide agreed service levels. Furthermore, cloud service providers might change their service levels, prices, and service offerings more often than traditional on-premise (owned by the service consumer) information technology providers.

With the advent of cloud computing, the information technology industry has been undergoing structural changes. These changes not only affect information technology companies themselves, but also the industry in general for which information technology has become an essential part of their business operations. IT departments face the need to provide infrastructure faster, driven by their lines of business, internal clients, suppliers and external customers. On the other hand, the pressure on cost effectiveness and quality of service continues to be very high. A high level of security is of utmost importance. Cloud computer environments have to fulfill similar requirements as traditional data centers in this regard, but are perceived to provide services faster and cheaper, and to have virtually endless resources available.

With container-based virtualization, isolation between containers can occur at multiple resources, such as at the filesystem, the network stack subsystem, and one or more namespaces, but not limited thereto. Containers of a container-based virtualization system can share the same running kernel and memory space. Container based virtualization is significantly different from the traditional hypervisor-based virtualization technology involving hypervisor based virtual machines (VMs) characterized by a physical computing node being emulated using a software emulation layer. Container based virtualization technology offers higher performance and less resource footprint when compared to traditional virtualization and has become an attractive way for cloud vendors to achieve higher density in the datacenter. Thus, containerization (i.e., operating a virtualized data processing environment using container-based virtualization) is changing how workloads are being provisioned on cloud infrastructure.

Data structures have been employed for improving operation of a computer system. A data structure refers to an organization of data in a computer environment for improved computer system operation. Data structure types include containers, lists, stacks, queues, tables and graphs. Data structures have been employed for improved computer system operation e.g., in terms of algorithm efficiency, memory usage efficiency, maintainability, and reliability.

Artificial intelligence (AI) denotes the capability of machines to demonstrate intelligence. AI research encompasses endeavors such as search algorithms, mathematical optimization, neural networks, and probability analysis. AI solutions integrate insights from diverse scientific and technological domains including computer science, mathematics, psychology, linguistics, statistics, and neuroscience. Machine learning, commonly defined as the study enabling computers to learn without explicit programming, is regarded to be a significant aspect of AI.

### SUMMARY

Shortcomings of the prior art are overcome, and additional advantages are provided, through the provision, in one aspect, of a method. The method can include, for example: examining application configuration data defining a configured software application and integration runtime engine profile data that specifies attributes of a plurality of integration runtime engines currently running within a computer environment; evaluating, in dependence on the examining, a suitability of respective ones of the plurality of the integration runtime engines for supporting running of the configured application; returning an action decision in dependence on the evaluating, wherein the action decision specifies a selected integration runtime engine for supporting running of the configured application; and deploying the configured software application to the selected integration runtime engine.

In another aspect, a computer program product can be provided. The computer program product can include a computer readable storage medium readable by one or more processing circuit and storing instructions for execution by one or more processor for performing a method. The method can include, for example: examining application configuration data defining a configured software application and integration runtime engine profile data that specifies attributes of a plurality of integration runtime engines currently running within a computer environment; evaluating, in dependence on the examining, a suitability of respective ones of the plurality of the integration runtime engines for supporting running of the configured application; returning an action decision in dependence on the evaluating, wherein the action decision specifies a selected integration runtime engine for supporting running of the configured application; and deploying the configured software application to the selected integration runtime engine.

In a further aspect, a system can be provided. The system can include, for example a memory. In addition, the system can include one or more processor in communication with the memory. Further, the system can include program instructions executable by the one or more processor via the memory to perform a method. The method can include, for example: examining application configuration data defining a configured software application and integration runtime engine profile data that specifies attributes of a plurality of integration runtime engines currently running within a computer environment; evaluating, in dependence on the examining, a suitability of respective ones of the plurality of the integration runtime engines for supporting running of the configured application; returning an action decision in dependence on the evaluating, wherein the action decision specifies a selected integration runtime engine for supporting running of the configured application; and deploying the configured software application to the selected integration runtime engine.

Additional features are realized through the techniques set forth herein. Other embodiments and aspects, including but not limited to methods, computer program product and system, are described in detail herein and are considered a part of the claimed invention.

### BRIEF DESCRIPTION OF THE DRAWINGS

One or more aspects of the present invention are particularly pointed out and distinctly claimed as examples in the claims at the conclusion of the specification. The foregoing and other objects, features, and advantages of the invention are apparent from the following detailed description taken in conjunction with the accompanying drawings in which:

FIG. 1 depicts a system having a computer environment, enterprise systems, clients, and UE devices according to one embodiment;

FIG. 2 depicts a cluster hosting integration runtime engines according to one embodiment;

FIG. 3 is a flowchart illustrating a method for performance by cluster manager interoperating with enterprise systems, UE devices, clients, and a cluster according to one embodiment;

FIG. 4 depicts a user interface according to one embodiment;

FIG. 5 depicts a predictive model according to one embodiment;

FIG. 6 depicts a cluster analysis according to one embodiment;

FIG. 7 depicts a cluster analysis according to one embodiment;

FIG. 8 depicts a predictive model according to one embodiment;

FIG. 9 depicts operations of a cluster manager according to one embodiment;

FIG. 10 depicts operations of a cluster manager according to one embodiment;

FIG. 11 depicts operations of a cluster manager according to one embodiment;

FIG. 12 depicts a method for performance by a cluster manager according to one embodiment;

FIG. 13 depicts an artificial neural network according to one embodiment;

FIG. 14 depicts a computing environment according to one embodiment.

### DETAILED DESCRIPTION

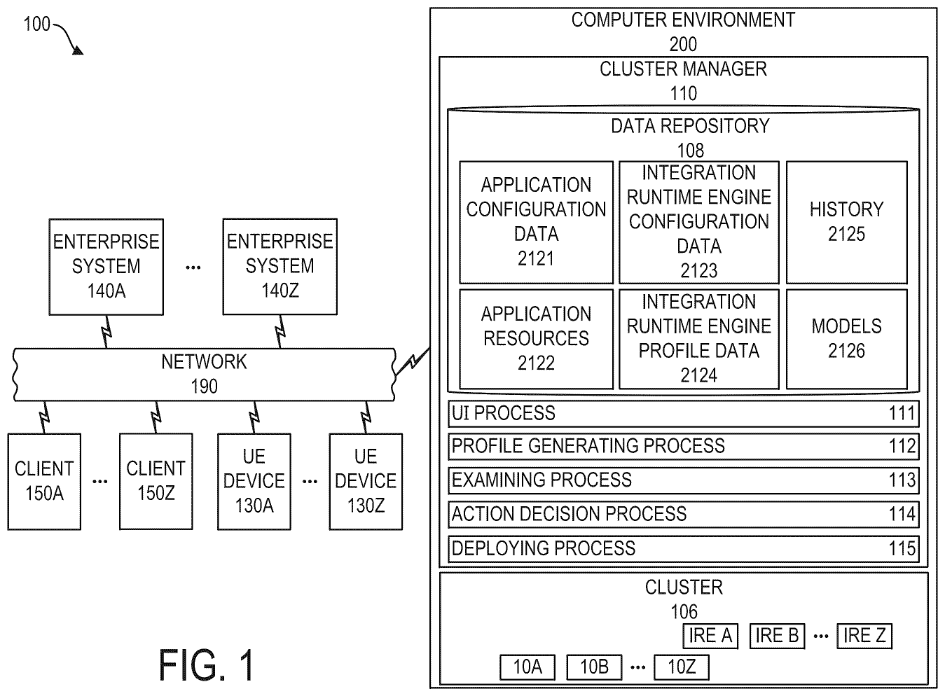

System 100 for use in improving computing resource utilization is shown in FIG. 1. System 100 can include computer environment 200, user equipment (UE) devices 130A-130Z, enterprise systems 140A-140Z and clients 150A-150Z. Computer environment 200, UE devices 130A-130Z, enterprise systems 140A-140Z and clients 150A-150Z can be computing node based systems, each having one or more computing node. Computer environment 200, UE devices 130A-130Z, enterprise systems 140A-140Z and clients 150A-150Z can be in communication with one another via network 190. Network 190 can be a physical network and/or a virtual network. A physical network can be, for example, a physical telecommunications network connecting numerous computing nodes, such as computer servers and computer clients. A virtual network can, for example, combine numerous physical networks or parts thereof into a logical virtual network. In another example, numerous virtual networks can be defined over a single physical network.

In one embodiment, computer environment 200 can be external from each of UE devices 130A-130Z, enterprise systems 140A-140Z, and clients 150A-150Z. In one embodiment, computer environment 200 can be co-located with one or more of an instance of UE devices 130A-130Z, enterprise systems 140A-140Z and clients 150A-150Z.

Embodiments herein recognize that it can be useful for an enterprise when configuring an application to also configure an integration runtime engine for supporting running of the application being configured. The configured integration runtime engine can include certain computing resources, e.g., one or more container-based virtual machine (container) having an associated computing resource allocation (e.g., in terms of CPU allocation, working memory allocation, storage memory allocation, and the like). The configured integration runtime engine can also include a certain one or more application supporting resource. The one or more application supporting resource can include, e.g., (a) a message flow engine for supporting message flows between tasks (b) a java virtual machine (JVM) for converting compiled bytecode that has been compiled from java source code into machine language, (c) node.js software, which can facilitate running of JavaScript on a host, and (d) a graphical data mapper (GDM). A GDM can facilitate graphical data map (.map) functionality.

Embodiments herein also recognize that efficiencies in computing resource utilization can be yielded by deploying an application to a previously deployed and currently running integration runtime engine. Embodiments herein include features so that a newly configured application can be deployed to a previously deployed currently running integration runtime engine. In one use case, the previously deployed concurrently running integration runtime engine can include one or more application supporting resource that can support newly deployed application. Thus, deployment and installation of the application supporting resource can be avoided.

Computer environment 200 can include cluster manager 110 for managing cluster 106. Cluster 106 can include a plurality of computing nodes 10A-10Z, which, in one embodiment, can be provided by physical computing nodes. Computing nodes 10A-10Z can host, in one embodiment, integrated runtime engines IRE A-IRE Z. In the context of UE devices 130A-130Z, enterprise systems 140A-140Z, clients 150A-150Z, computing nodes 10A-10Z, and integration runtime engines IRE A-IRE Z, “Z” can refer to an integer of any arbitrary value.

Clusters herein represented by cluster 106, according to one embodiment, can perform functions in common with clusters of a Kubernetes® container management system. For example, computing nodes 10A-10Z, according to one embodiment, can have features and functions in common with a worker node of a Kubernetes® container management system. Cluster manager 110 can have features and functions in common with a Kubernetes® master node, according to one embodiment. Kubernetes® is a trademark of the Linux Foundation. According to one embodiment, a cluster can have features in common with a Docker® Swarm™ container management system. Docker® Swarm™ is a trademark of Docker, Inc.

Cluster manager 110 can include data repository 108 and can be configured to run various processes. Data repository 108 of cluster manager 110 can store various data.

In images area 2121, data repository 108 can store images provided by container images. Images in images area 2121 can be divided into various namespaces, wherein namespaces can be assigned on a tenant-by-tenant basis, wherein a first tenant can be assigned a first namespace, and a second tenant can be assigned a second namespace. Container images stored in images area 2121 can be received from various enterprises associated to various different enterprise tenants which enterprise tenants are associated to different ones of enterprise systems 140A-140Z. Additionally, or alternatively, container images can be configured or designed on behalf of enterprise tenants by alternative container image development sources.

Data repository 108 can store various data. Data repository 108 in application configuration data area 2121 can store application configuration data. In response to being presented prompting data in a user interface by cluster manager 110, a user such as an administrator user, can define application configuration data that specifies tasks and an order of operation defining an application. Received application configuration data defined by an administrator user received by cluster manager 110 can be stored in application configuration data area 2121.

In application supporting resources area 2122, data repository 108 can store application supporting resources. Application supporting resources area 2122 of data repository 108 can store application supporting resources supporting running of applications that are defined in an administrator user with use of application configuration data.

Data repository 108 in integration runtime engine configuration data area 2123 can store integration runtime engine configuration data defined by an administrator user. Integration runtime engine configuration data stored in integration runtime engine configuration data area 2123 can include, e.g., provisioning data for provisioning containers having application supporting resources.

Data repository 108 in integration runtime engine profile data area 2124 can store data specifying applications currently running and deployed to an active integration runtime engine as well as metrics data that specifies parameters defining operating performance of a currently running integration runtime engine.

Data repository 108 in history area 2125 can store history data that specifies integration runtime engine profile data of historical integration runtime engines running within computer environment 200. Data repository 108 in models area 2126 can store, e.g., trained predictive models trained for return of action decisions.

Cluster manager 110 can run various processes including UI process 111, profile generating process 112, examining process 113, action decision process 114, and deploying process 115. Cluster manager 110 running UI process 111 can include cluster manager 110 presenting a user interface to an administrator user that facilitates an administrator user to define application configuration data and integration runtime engine configuration data.

Application configuration data can include data defining an application running on an integration runtime engine. Integration runtime engine configuration data can define an integration runtime engine, e.g., a set of application supporting tasks for supporting tasks defining an application.

Cluster manager 110 running profile generating process 112 can include cluster manager 110 generating profile data that characterizes one or more integration runtime engine currently running within one or more cluster 106 of computer environment 200. Cluster manager 110 running profile generating process 112 can include cluster manager 110 processing integration runtime engine configuration data and metrics data defining performance characteristics of a currently active integration runtime engine.

Cluster manager 110 running examining process 113 can include cluster manager 110 examining application configuration data defining an application requested for deployment with integration runtime engine profile data that characterizes one or more integration runtime engine currently active and running on a cluster within computer environment 200.

Cluster manager 110 running action decision process 114 can include cluster manager 110 returning an action decision for deployment of an application for which deployment was requested in dependence on a result of an examining in accordance with examining process 113. Cluster manager 110 running deploying process 115 can include cluster manager 110 deploying an application for which deployment was requested in dependence on an action decision for deployment return by running of action decision process 114.

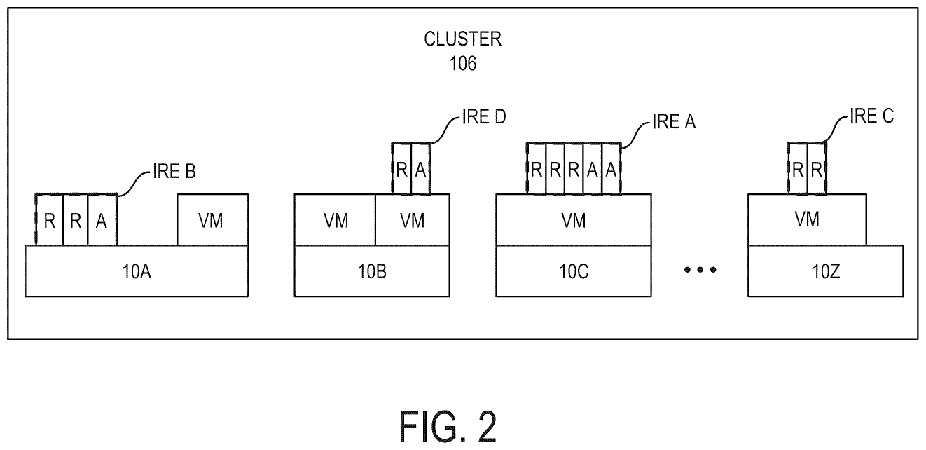

Referring now to cluster 106, cluster 106 can include a plurality of computing nodes 10A-10Z hosting a plurality of integration runtime engines IRE A, IRE B, IRE C and IRE Z. Further details of cluster 106, in one embodiment, are shown in FIG. 2. Cluster 106 can include a plurality of computing nodes 10A-10Z which can be provided by physical computing nodes. Respective integration runtime engines can be hosted on one or more computing node of plurality of computing nodes 10A-10Z. Some or all of the plurality of computing nodes 10A-10Z can host hypervisor-based virtual machines VMs, which respective VMs can host one or more integration runtime.

In the example of FIG. 2, integration runtime engine IRE A can be defined by first, second and third application supporting resources R and first and second applications A. IRE A can run on a VM that is hosted on computing node 10C. In the example of FIG. 2, integration runtime engine IRE B can be defined by first and second application supporting resources R and an application A. IRE B can run on computing node 10A. In the example of FIG. 2, integration runtime engine IRE C can be defined by first and second application supporting resources R. IRE C can run on a VM that is hosted on computing node 10Z. IRE C is depicted in a state where IRE C is deployed and running but is not currently supporting any running applications. The state of IRE C depicted in FIG. 2 can be referred to as a “blank IRE”. In the example of FIG. 2, integration runtime engine IRE D can be defined by an application supporting resource R and an application A. IRE D can run on a VM hosted by computing node 10B.

The various integration runtime engines IRE A-IRE Z can include states. States of an integration runtime engine IRE can include, e.g., a pre-deployed state where the integration runtime engine can exist as a configuration file as defined by an administrator user, a deployed blank IRE state wherein the integration runtime engine is deployed and running but is not yet supporting any applications, and one or more deployed loaded IRE state in which the integration runtime engine supports the running of one or more application. As additional applications are deployed to a certain integration runtime engine, or terminated, loading and state of the integration runtime engine can change. Each integration runtime engine of a set of integration runtime engines IRE A-IRE Z can have a finite lifecycle, wherein the integration runtime engine is, e.g., deployed, supports running of one or more application and then is terminated by cluster manager 110. After a given integration runtime engine is decommissioned, it can be redeployed often to a different one or more computing node of computing nodes 10A-10Z of cluster 106.

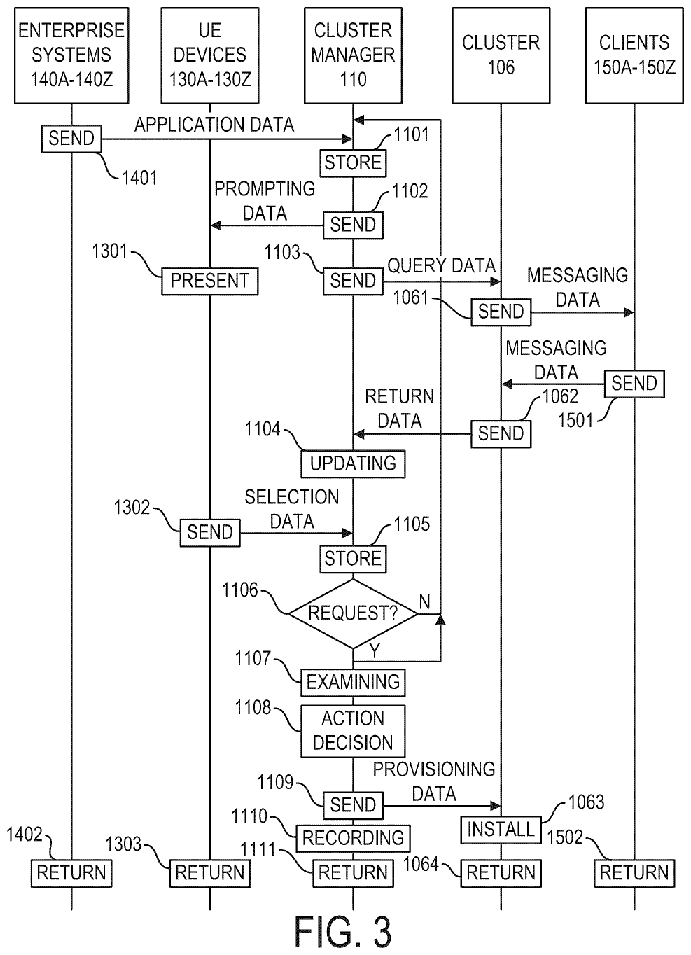

A method for performance by cluster manager 110 interoperating with enterprise systems 140A-140Z, UE devices 130A-130Z, cluster 106 and clients 150A-150Z is set forth in reference to the flowchart of FIG. 3. At block 1401, enterprise systems 140A-140Z can be sending application data for receipt by cluster manager 110.

The application data sent at block 1401 can include resource data for support of running of an application. At block 1401, enterprise systems 140A-140Z can be sending application data, e.g., images, service level agreement data (SLA requirements) data and the like, to cluster manager 110 and in response to the application data, cluster manager 110 at store block 1101 can store the application data to images area 2121 of data repository 108. On receipt of the application data, cluster manager 110 can store received application data into application supporting resources area 2122 at store block 1101. Application data sent at block 1401 can be defined by an administrator user through user interface UI of a UE device of the user. Such a user can be an administrator user who is an agent of an enterprise associated to one of enterprise systems 140A-140Z. On completion of store block 1101, cluster manager 110 can proceed to send block 1102. At send block 1102, cluster manager 110 can send prompting data for presentment on a user interface displayed on the display of a UE device. Prompting data sent at block 1102 can include prompting data that prompts the user to define application data as well as integration runtime engine configuration data.

A user interface 3102 defined by the prompting data sent at block 1102 is shown in FIG. 3. User interface 3102 can include application configuration area 3104 and integration runtime engine configuration area 3106. Application configuration area 3104 can be used to configure application data and integration runtime engine configuration area 3106 can be used to configure an integration runtime.

At present block 1301, user interface 3102 defined by prompting data sent at block 1102 can be presented to an administrator user. The administrator user can be an administrator user agent who is an agent of an enterprise of enterprise systems 140A-140Z. In one embodiment, application configuration area 3104 can include graphical user interface GUI features to enable administrator user specify tasks that define an application for deployment as well as an ordering of performance of the various tasks. In one example, a user can employ drag-and-drop functionality to select tasks from tasks menu 3131 of application configuration area 3104 for selection of tasks to be performed in an application for deployment. In the embodiment example depicted in FIG. 3, an administrator user can select task 3141, task 3142, task 3143, and task 3144 for operation in an application for deployment. With use of application configuration area 3104, an administrator user can also select an order of execution of the various selected tasks. In reference to application configuration area 3104, a user can establish selection arrows to establish an order of an execution wherein task 3141 completes prior to task 3143, and further so that tasks 3143 and task 3142 complete before task 3144. One task can relate, e.g., to collection and processing of IoT data. One task can relate, e.g., processing end user data entered into a user interface. One task can relate, e.g., to updating a customer list. One task can relate, e.g., to updating a sales force list. One task can relate, e.g., to querying a database. One task can relate, e.g., to outputting data to an end user via a user interface. One task can relate, e.g., to control of an industrial machine. One task can relate, e.g., to process data according to a predetermined or adaptive process. Numerous other types of tasks are possible. Examples of other tasks that can be selected with use of task menu 3131 can include, e.g., a salesforce input task, a trace task, a TCPIP server task, and a compute task, a client order initiation task, an inventory update task, a payment task, a notification task, and the like. In application supporting resources area 2122, data repository 108 can include application supporting resources, e.g., containers for support of performance of the various selected tasks.

Cluster manager 110, in one aspect, can be configured with the functionality to orchestrate a selection of application supporting resources, e.g., containers for performance of various tasks selected by a user with use of application configuration area 3104 in accordance with an order of operation selected by a user with use of application configuration area 3104.

When an application for deployment has been configured to the satisfaction of an administrator user with use of application configuration area 3104, the administrator user can activate deploy button 3150 for generating a deployment request for deployment of an application that the user has configured using graphics area 3105. Referring to further features of user interface 3102, a user can alternatively select for deployment a prior configured application which may or may not have previously run on cluster 106. A user can select for deployment a previously configured application using selection area 3152 which can be defined by a dropdown menu. User interface 3102 can be configured to present full parameter information of an historical configured application via right click of a highlighted application within area 3152 (wherein left click can be used to select deployment for example). On selection of an application for deployment, a deployment request can be generated.

With use of integration runtime engine configuration area 3106, a user can configure computing resources for use in supporting running of a configured application of the user, wherein the application has been configured using application configuration area 3104. Thus, in one example, a user can use integration runtime engine configuration area 3106 for configuring an integration runtime engine that supports running of an application configured using application configuration area 3104. With use of integration runtime engine configuration area 3106, a user can select the provisioning of computing resources for supporting running of an application configured using application configuration area 3104.

With use of integration runtime engine configuration area 3106, a user can, e.g., configure one or more container having application supporting resources for supporting running of an application. With use of integration runtime engine configuration area 3106 a user can assign computing resource allocations to such one or more container, such as CPU allocations, working (system) memory allocations, and storage memory allocations Sample code for provisioning a container is shown in Table A.

```
TABLE A
  #ecs_container_setup.tf
  provider “ABC” {
    region = “us-west-2” # specify your region
  }
  #Step 1: Define ECS Cluster
  resource “ABC_ecs_cluster” “example” {
    name = “example-cluster”
  }
  #Step 2: Define IAM Roles
  resource “ABC_iam_role” “ecs_task_execution_role” {
    name = “ecs_task_execution_role”
  assume_role_policy = jsonencode({
  Version = “2012-10-17”,
  Statement = [
      {
  Action = “sts:AssumeRole”,
    Principal = {
  Service = “ecs-tasks.cloudABC.com”
    },
    Effect = “Allow”,
  Sid = “”,
        },
    ],
    })
  }
  resource “ABC_iam_role_policy_attachment” “ecs_task_execution_role_policy” {
  role = ABC_iam_role.ecs_task_execution_role.name
    policy_arn = “arn:ABC:iam::ABC:policy/service-role/cloudECSTaskExecutionRolePolicy”
  }
  # Step 3: Define Task Definition
  resource “ABC_ecs_task_definition” “example” {
  family = “example-task”
  network_mode = “ABCvpc”
  requires_compatibilities = [“FARGATE”]
  cpu = “512” # 0.5 vCPU
  memory = “1024” # 1 GB
  execution_role_arn = ABC_iam_role.ecs_task_execution_role.arn
  container_definitions = jsonencode([
    {
  name = “example-container”
  image = “nginx:latest”
  essential = true
  portMappings = [
{
    containerPort = 80
    hostPort = 80
  },
        ]
    logConfiguration = {
      logDriver = “ABClogs”
      options = {
    “ABClogs-group” = “/ecs/example”
  “ABClogs-region” = “us-west-2”
    “ABClogs-stream-prefix” = “ecs”
  }
      }
    # Storage and other configurations can be added here
# E.g., mountPoints, volumes, environment variables, etc.
      }
    ])
  }
  # Step 4: Define ECS Service
  resource “ABC_ecs_service” “example” {
  name = “example-service”
  cluster = ABC_ecs_cluster.example.id
  task_definition = ABC_ecs_task_definition.example.arn
  desired_count = 1
  launch_type = “FARGATE”
  network_configuration {
  subnets = [“subnet-0123456789abcdef0”] # specify your subnet ID
  security_groups = [“sg-0123456789abcdef0”] # specify your security group ID
      }
  }
```

In one embodiment, an administrator user can author in integration runtime engine configuration area 3106 Terraform code for configuration of an integration runtime engine. In another example, user interface 3102 can include GUI features so that administrator user can define software code for configuring an integration runtime engine with use of code development menus, prompted for selections and graphical aids.

When an integration runtime engine for deployment has been configured to the satisfaction of an administrator user with use of code development area 3107 of integration runtime engine configuration area 3106, the administrator user can activate select button 3160 for generating a deployment request for deployment of the new integration runtime engine for supporting running of an application selected for deployment using application configuration area 3104. Referring to further features of user interface 3102, a user can alternatively select for supporting running of a selected application a prior configured integration runtime engine which may or may not be currently active and running within cluster 106. A user can select a currently running integration runtime engine for supporting running of a configured application using selection area 3162 which can be defined by a dropdown menu. User interface 3102 can be configured to present full parameter information of a currently running integration runtime engine via right click of a highlighted application within area 3162 (wherein left click can be used to select a highlighted integrated runtime engine as the targeted integration runtime engine for supporting running of the selected application for example). A user can select an inactive, historical previously running integration runtime engine for supporting running of a configured application using selection area 3164 which can be defined by a dropdown menu. User interface 3102 can be configured to present full parameter information of a currently running integration runtime engine via right click of a highlighted application within area 3164 (wherein left click can be used to select a highlighted integrated runtime engine as the targeted integration runtime engine for supporting running of the selected application for example).

In a further aspect of user interface 3102, an administrator user can configure weights of Eq. 1 herein using area 3170. In one envisioned use case, user interface 3102 can be presented for use on a UE device of UE devices 130A-130Z of an administrator user who is an agent user of an enterprise associated to one of enterprise systems 140A-140Z. In one envisioned use case, user interface 3102 can be presented for use on a UE device of UE devices 130A-130Z of an administrator user who is an agent user of cluster manager 110 that provides a hosting service to enterprise systems 140A-140Z.

Embodiments herein recognize that it can be useful for an enterprise when configuring an application to also configure an integration runtime engine for supporting running of an application where a configured integration runtime engine has certain computing resources, e.g., one or more container having assigned computing resources, and certain application supporting resources (which may or may not be containerized), e.g., a message flow engine, a JVM, a node.js, a GDM as set forth herein. Embodiments herein also recognize that efficiencies in computing resource utilization can be yielded by deploying an application to a previously deployed and currently running integration runtime engine. Embodiments herein include features so that a newly configured application can be deployed to a previously deployed currently running integration runtime engine. In one use case, the previously deployed concurrently running integration runtime engine can include one or more application supporting resource that can support the newly deployed application. Thus, deploying the application to a currently running integration runtime engine can avoid deployment and installation of one or more application supporting resource.

Referring again to the flowchart of FIG. 3, a UE device of UE devices 130A-130Z on which user interface 3102 is presented can be sending selection data defined by a user with use of user interface 3102. The selection data can include selection data defined by application configuration data specified with use of application configuration area 3104 and/or can include selection data defined by integration runtime engine configuration data specified with use of integration runtime configuration area 3106. On receipt of the selection data sent at block 1302, cluster manager 110 at store block 1105 can store the selection data and can proceed to request decision block 1106. At request decision block 1106, cluster manager 110 can ascertain whether a user has specified a request for deployment of a configured application, e.g., with use of deploy button 3150 of selection area 3104 as described in reference to the user interface 3102 of FIG. 3.

On the determination that a user has not made a request for application deployment, cluster manager 110 can return to a stage preceding store block 1101 and can iteratively perform the loop of blocks 1101-1106 until the time at which cluster manager 110 at block 1106 determines that a user has specified a request for deployment of a newly configured application. During the performance of the loop of blocks 1101-1106, cluster manager 110 can iteratively perform blocks 1103 and 1104. At block 1103, cluster manager 110 can send query data for query of cluster 106. The query data sent at block 1103 can include query data for ascertaining a state of one or more currently running integration runtime engine currently running on cluster 106.

In a use case depicted in reference to FIG. 2, there are four integration runtime engines IRE A-IRE D currently running on cluster 106. In another use case, there could be zero currently running integration runtime engines or N currently running integration runtime engines. Referring to cluster 106, the integration runtime engines currently running within cluster 106 at send block 1061 can be iteratively sending message data to end user clients 150A-150Z being served by one or more application supported by one or more integration runtime engine and at send block 1501, the end user clients 150A-150Z can be sending return messaging data for receipt by the running integration runtime engines running on cluster 106.

At send block 1062, cluster 106 can be sending return data for receipt by cluster manager 110 in response to the query data sent at block 1103 for ascertaining a state of any integration runtime engines currently running within cluster 106. The return data sent at block 1062 can include, e.g., metrics data and/or state transition data which indicates whether an integration runtime engine will be in a transitioning state in a next time. Metrics data can include metrics data that specifies a current loading of an integration runtime engine.

Returned metrics data can include, e.g., infrastructure parameter values, virtualization parameter values, infrastructure utilization parameter values, network utilization parameters values, and reliability parameter values. The described parameter values can characterize the various currently active currently running integration runtime engines currently running within cluster 106.

Infrastructure parameter values can include such parameter values as numbers of computing nodes provided by physical computing nodes, computing node (CPU) capacity, memory capacity, storage capacity, and network capacity (bandwidth). Computing node capacity, memory capacity, and storage capacity can be expressed in terms of aggregate computer environment capacity or can be reported on a per computing node basis.

Virtualization parameter values can include, e.g., numbers of virtual machines and/or resource provisioning parameter values associated to the various virtual machines. Virtual machines herein can include, e.g., hypervisor-based virtual machines and/or container-based virtual machines.

Infrastructure utilization parameters can include, e.g., CPU utilization parameters, memory utilization parameters, and/or storage utilization parameters. It will be understood that infrastructure availability parameter values can be derived at any time with use of the reported utilization parameters based on the contemporaneously reported capacity parameter values.

Network utilization parameters can include, e.g., throughput parameter values expressed, e.g., in terms of bits per second (BPS), response time parameter values, latency parameter values, concurrent users parameter values, which specifies the number of active users at a given time, and/or a requests per second (RPS) parameter value which specifies a number of requests for a digital asset received over time. It will be understood that network availability parameter values can be derived at any time with use of the reported utilization parameters based on the contemporaneously reported capacity parameter values, including network capacity parameter values.

Reliability parameter values can include, e.g., packet loss (error rate) parameter values, mean time to failure (MTTF) parameter values, mean time to repair (MTTR) parameter values, mean time between failure (MTBR) parameter values, rate of occurrence failure (ROCOF) parameter values, and the like.

On receipt of the return data sent at block 1062, cluster manager 110 at updating block 1104 can perform updating of profile data that specifies a profile of one or more integration runtime engine currently running within cluster 106. Profile data that characterizes one or more integration runtime engine currently running within cluster 106 can include a list of applications for which deployment was requested by an administrator user and which are currently running being supported by the integration runtime engine as well as application supporting resource data which specifies the application supporting resources associated to the respective applications being supported by a respective integration runtime.

Profile data that characterizes one or more integration runtime engine currently deployed and running can also include metrics data that specifies the current loading of the various integration runtime engines. In generating updated profile data at updating block 1104, cluster manager 110 can query history area 2125 of data repository 108 of FIG. 1, which can include the record of all past integration runtime engine and application deployments to cluster 106 for determination of any integration runtime engines currently deployed and any applications currently deployed to the various integration runtime engines.

At updating block 1104, cluster manager 110 can perform updating of history area 2125, as well as profile data of profile data area 2124 that characterizes currently running integration runtime engines currently running within cluster 106. Specifically, at updating block 1104, cluster manager 110 can perform updating of history area 2125 when returned data returned by send block 1062 specifies that an application and or an integration runtime engine has been decommissioned and terminated.

An example of integration runtime engine profile data that can be updated and provided at updating block 1104 is set forth in reference to Table B. As shown in Table B, integration runtime engine profile data can include identifiers for a set of integration runtime engines currently running within cluster 106.

TABLE B
(Integration runtime engine profile data)

| | | IRE provisioning | | | |
|---|---|---|---|---|---|
| | | parameters (e.g., | | | |
| | | number of | | | |
| | | containers and | | Application | Loading metrics |
| | Integration | computing resource | Applications | supporting | (iteratively |
| | runtime engine | allocations to | currently | resources and | updated during |
| Row | identifier | such containers) | deployed to IRE | statuses | running of IRE) |
| 1 | XX | XX | XX | XX | XX |
| 2 | XX | XX | XX | XX | XX |
| 3 | XX | XX | XX | XX | XX |

Integration runtime engine profile data can include computing resource provisioning data (e.g., number of containers, CPU, system memory and storage memory allocations) that specifies computing resource provisioning for the various integration runtime engines, application identifiers specifying applications currently supported by the integration runtime engine, application supporting resources, status information of the various application supporting resources, e.g., installed/not installed, and metrics data specifying the current loading of the virtual machines defining the integration runtime engine.

As noted, cluster manager 110 can iteratively perform the loop of blocks 1101-1106 until such time cluster manager 110 at block 1106 determines that a deployment request for requesting deployment of a configured application has been received from a UE device of UE devices 130A-130Z via a user interface, such as user interface 3102 as set forth in reference to FIG. 3. On the determination at block 1106 that a deployment request for deploying a configured application has been received, cluster manager 110 can proceed to examining block 1107. It will be seen that even where cluster manager 110 determines that a deployment request for deploying an application has been received, cluster manager 110 can still iteratively return to a stage prior to block 1104 and can be iteratively performing the loop of blocks 1101-1106 iteratively even where cluster manager 110 branches to perform block 1107 and ensuing blocks.

At block 1107, cluster manager 110 can perform examining. The examining at block 1107 can include cluster manager 110 performing examining of selection data defined by application configuration data established via administrator user selections using application configuration area 3104 of user interface 3102 as set forth in FIG. 3 with updated integration runtime profile data that characterizes one or more integration runtime engine currently running within cluster 106 as updating during the most recent iteration of updating block 1104. Cluster manager 110 at block 1107 can compare application configuration data for which deployment has been requested to updated integration runtime engine profile data of one or more integration runtime engine currently running within cluster 106 and in response to the examining, cluster manager 110 can proceed to block 1108 to perform an action decision in dependence on the examining performed at block 1107.

Cluster manager 110 at action decision block 1108 can return an action decision to deploy a configured application for which deployment has been requested in dependence on the examining performed at block 1107.

Cluster manager 110, in one embodiment at examining block 1107, can perform examining of application configuration data in reference to profile data characterizing one or more integration runtime engine currently running within cluster 106 with use of the formula below of Eq. 1.

$$S = F 1 W 1 + F 2 W 2 + F 3 W 3 + F 4 W 4 + F 5 W 5 \qquad ( Eq . 1 )$$

Referring to Eq. 1 where Eq. 1 is a suitability scoring equation for use in scoring and evaluating suitability of a given integration runtime engine's supporting an application for which deployment has been requested, where the integration runtime engine is active and currently running within cluster 106. In reference to Eq. 1, S can be an overall scoring value scoring suitability of deploying an application configured with user-defined configuration data in reference to a given integration runtime engine currently running within cluster 106, F1-F5 are factors and W1-W5 are weights associated to the various factors. In one aspect, cluster manager 110 can be configured so that an administrator user can configure weights W1-W5 (e.g., dropping any one or more of the weights to 0%, or increasing any single weight to 100%) using area 3170 of user interface 3102 as shown in FIG. 3. In one embodiment, weights W1-W5 can be adaptively determined.

According to one embodiment, factor F1 can be a deployment latency factor. Embodiments herein recognize that certain application deployments can exhibit significant deployment latencies where application supporting resources are required to support functions of the application.

Embodiments herein recognize, for example, that installation of certain application supporting application supporting resources such as installation of a Java virtual machine (JVM) may require, e.g., tens of seconds to minutes in some situations. Embodiments herein recognize that such latencies can be avoided by deployment of an application to the currently running integration runtime engine that has previously installed the required application supporting JVM resource.

Cluster manager 110 assigning scoring values under factor F1 can predict deployment latency of an application on a certain currently running integration runtime engine in dependence on a predicted installation time for installation of required resources of the application. In performing such predicting, cluster manager 110 can decrement the predicted installation time for a resource, if the resource has previously been installed in the running of the current integration runtime engine being evaluated for deployment of the new application for deployment.

Cluster manager 110 can assign scoring values under factor F1 in inversely proportional predicted installation time for installing required resources of the application. Cluster manager 110 assigning scoring values under factor F1, in one embodiment, can employ a decision data structure as set forth in Table C.

TABLE C

| | | | | Resource | Installed or Not Installed |
|---|---|---|---|---|---|
| | Application | | | Predicted | status (determined at |
| | (can be newly | | | installation | runtime at examining |
| | created | | | time | block 1107 for the |
| | application | | | (iteratively | application that is |
| | or historical | | | updated as | selected for deployment |
| | application | Task order | Application | history | and for the integration |
| | selected for | relationship | supporting | data is | runtime engine(s) being |
| Row | redeployment) | graph | resource(s) | accumulated) | evaluated at block 1107) |
| 1 | AAB123 | XX | Resource_1 | XX | XX |
| | | | Resource_2 | XX | XX |
| 2 | AAB129 | XX | Resource_7 | XX | XX |
| | | | Resource_2 | XX | XX |
| | | | Resource_9 | XX | XX |
| 3 | AAB133 | XX | Resource_3 | XX | XX |
| | | | Resource_2 | XX | XX |
| 4 | . . . | | . . . | | |

In reference to Table C, Table C can include a list of tasks of a configuration, e.g., as selected using user interface 3102 as set forth in FIG. 3, a resource column specifying resources associated to the various tasks, e.g., one task can include a JVM application supporting resource (e.g., mapping to Resource_1) and another task can include an SQL resource (e.g., mapping to Resource_9), for example.

The decision data structure of Table C can also include a predicted installation time column in which there is specified a predicted installation time associated to the required resource where the resource has not been previously installed and decision data structure of Table C can further include a status column that specifies whether the required resources currently installed on the current integration runtime engine being evaluated for deployment of the current application.

Referring to the decision data structure of Table C, cluster manager 110 can in the background be iteratively updating the predicted installation time in dependence on history data accumulated into history area 2125 each time the given resource has been installed by cluster manager 110. Cluster manager 110 can assign predicted values within the predicted installation time column of Table C by aggregating historical aggregating, e.g., averaging historical installation times for installing the specified application supporting resource. Cluster manager 110 can also be iteratively updating the status column in dependence on current profile data that characterizes each integration runtime engine currently running within cluster 106.

Cluster manager 110 assigning scoring values under factor F1 can aggregate the predicted installation times for each resource, decrementing the time amounts where the status column indicates that the certain resource has been previously installed on the integration runtime engine being evaluated.

Further in reference to factor F1, cluster manager 110 can bias scoring values under factor F1 in dependence on an observed examination of an order of execution of various tasks defining an application. As set forth in reference to FIG. 3 and Table B, application configuration data can specify an order of execution of tasks, e.g., in one scenario, a first task can be required to be complete before a second task commences.

Cluster manager 110, in one embodiment, can bias provisional scoring values assigned under factor F1 in dependence on an examined order of execution ascertained by cluster manager 110 by examination of application configuration data as defined by an administrator user using user interface 3102. For example, were a certain task being evaluated using Table C is a subsequent task in an order of execution subsequent to one or more prior task that must complete prior to the certain task commencing, cluster manager 110 can reduce the scoring penalty provisionally applied based on a lengthy installation time associated to a task resource.

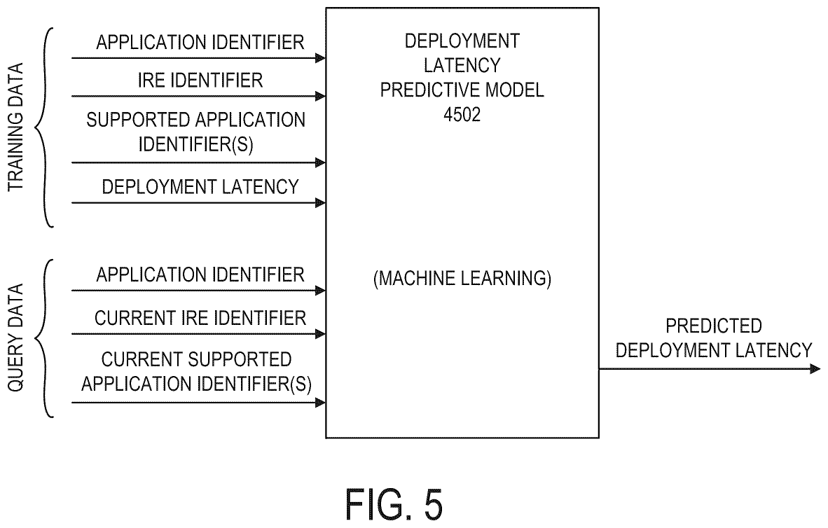

In addition, or alternatively, in reference to factor F1, cluster manager 110 can query a predictive model predicting deployment latencies as set forth in FIG. 5. For assigning scoring values under factor F1, cluster manager 110 can query deployment latency predictive model 4502 as set forth in FIG. 5.

Deployment latency predictive model 4502 can be trained via supervised learning with iterations of training data and once trained, deployment latency predictive model 4502 can be operational to provide predictions as to predicted deployment latency for installation of given application on deployment thereof. Iterations of training data for training deployment latency predictive model 4502 can include iterations of training data that specify (a) an application identifier for the application that has been deployed, the integration runtime engine identifier on which the historical deployment of the identified application was deployed, (b) a supported application identifier specifying the applications supported by the historical integration runtime engine, when the deployment occurred, and (c) the deployment latency observed for the historical deployment.

Cluster manager 110 can obtain iterations of training data by extracting historical records from history area 2125 specifying deployment latencies for prior historical application deployments by cluster manager 110 onto various historical integration runtime engines under differing loading conditions. Deployment latency predictive model 4502, once trained, can be configured to respond to query data. Query data for querying deployment latency predictive model 4502 can include a data set that includes (I) an application identifier for the new application being deployed for the current application for which deployment is requested, (II) a current integration runtime engine identifier that specifies the integration runtime engine being evaluated with use of Eq. 1, and (III) current supported application identifier(s) specifying the currently supported applications currently deployed to the integration runtime engine being evaluated with use of Eq. 1.

Where the current application for which deployment request has been made is a newly created application different from prior application identifiers associated to applications used for training deployment latency predictive model 4502, cluster manager 110 can discover a prior historical application identifier similar to the current new application with use of clustering analysis that is explained with reference to FIG. 5.

FIG. 5 depicts clustering analysis diagram for discovery and identification of an historical application similar to a newly created application. Referring to the clustering analysis diagram of FIG. 5, data point 5102 indicated with dots represent historical applications that had previously been deployed by cluster manager 110 and data point 5104 indicated with an X is a data point representing a newly configured application.

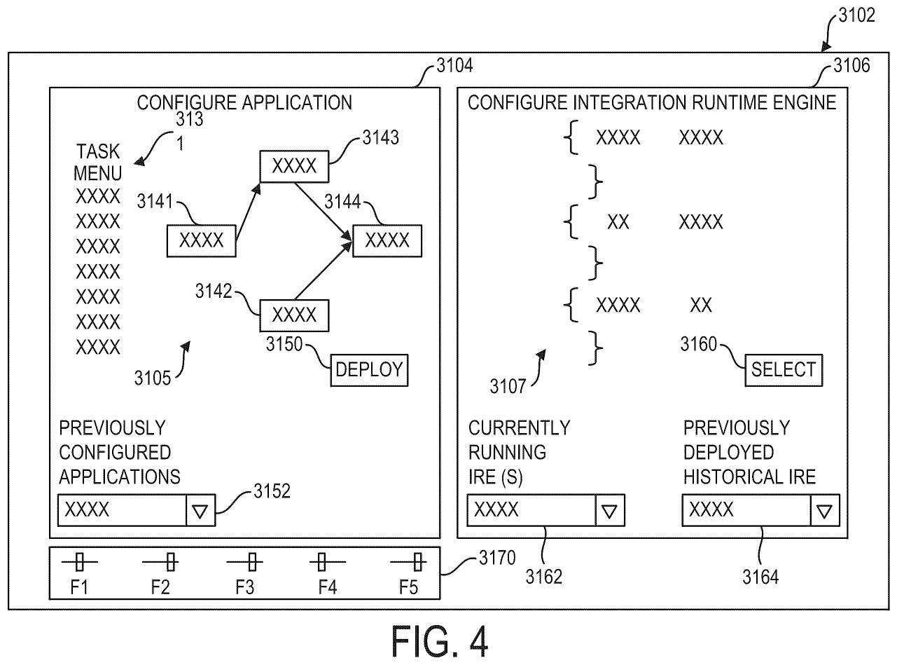

Referring to the clustering analysis diagram of FIG. 5, cluster manager 110 can employ clustering analysis to identify a prior application historically deployed by cluster manager 110 in dependence on clustering analysis. In reference to the clustering analysis of FIG. 5 where datapoint 5104 represents a newly configured application for which a deployment request has been determined at the most recent iteration of block 1106, cluster manager 110 can identify the historical application associated to the datapoint 5102 at location A as the historical application having greatest similarity to the new application represented by datapoint 5104 based on smallest Euclidean distance. With the most similar historical application identified in reference to the deployment latency predictive model 4502 of FIG. 4, cluster manager 110 can employ the identified and discovered historical similar application identifier for querying of deployment latency predictive model 4502 in order to return a prediction as to the predicted deployment latency for deploying the current application represented by data point 5104. Cluster manager 110 can also use the same clustering analysis to substitute similar historical commonly deployed applications having a threshold number of prior deployments by cluster manager 110 for ones of the currently supported applications currently deployed to the integration runtime engine specified as query data where the currently supported applications do not have a threshold number of prior deployments by cluster manager 110.

Referring to factor F2, factor F2 can be a predicted availability factor. In some situations, an integration runtime engine being evaluated can be significantly loaded which will influence the assigned scoring value assigned to it by cluster manager 110 under factor F2. For evaluating loading availability of an integration runtime engine being evaluated, cluster manager 110 can examine integration runtime engine profile data (Table A) for the integration runtime engine as has been updated in updated profile data for the engine updated at block 1104.

Cluster manager 110 can scale scoring values under factor F2 in a manner inversely dependent on dependence on the predicted availability of the integration runtime engine which can be determined by examining current availability and predicted loading, i.e., resource consumption ascertained by query of predictive model 7502. Cluster manager 110 can be configured to assign sufficiently negative scoring values under factor F2 where the integration runtime engine being evaluated does not exhibit a predicted threshold level of availability, thus automatically disqualifying the evaluated integration runtime engine.

In connection with the predicted consumption for the application which can be ascertained by query of computing resource consumption predictive model 7502, cluster manager 110 can assign scoring values under factor F2 in dependence on querying of computing resource consumption predictive model 7502, which can be trained with use of training data in a manner similar to the training of deployment latency predictive model 4502.

Computing resource consumption predictive model 7502 can be trained via supervised learning with iterations of training data and once trained, computing resource consumption predictive model 7502 can be operational to provide predictions as to predicted deployment latency for a given application. Iterations of training data for training computing resource consumption predictive model 7502 can include iterations of training data that specify (a) an application identifier for the application that has been deployed, (b) the integration runtime engine identifier on which the historical deployment of the identified application was deployed, (c) a supported application identifier specifying the applications deployed to the historical integration runtime engine when the deployment occurred, and (d) computing resource consumption (utilization) parameter values associated to the historical deployment such as infrastructure utilization parameters which can include, e.g., CPU utilization parameters, memory utilization parameters, and/or storage utilization parameters.

Cluster manager 110 can obtain iterations of training data by extracting historical records from history area 2125 specifying deployment utilization parameter values for prior historical application deployments by cluster manager 110 onto various historical integration runtime engines under differing loading conditions. Computing resource consumption predictive model 7502, once trained, can be configured to respond to query data. Query data for querying computing resource consumption predictive model 7502 can include a dataset that includes (I) an application identifier for the new application being deployed for the current application for which deployment is requested, (II) a current integration runtime engine identifier that specifies the integration runtime engine being evaluated with use of Eq. 1, and (III) current supported application identifier(s) specifying the currently supported applications currently deployed to the integration runtime engine being evaluated with use of Eq. 1. Where the current application for which deployment request has been made is a newly created application different from prior application identifiers associated to applications used for training deployment latency predictive model 4502, cluster manager 110 can discover a prior historical application identifier similar to the current new application with use of clustering analysis that is explained with reference to FIG. 5. Cluster manager 110 can also use the same clustering analysis to substitute similar historical commonly deployed applications having a threshold number of prior deployments by cluster manager 110 for ones of the currently supported applications currently deployed to the integration runtime engine specified as query data where the currently supported applications do not have a threshold number of prior deployments by cluster manager 110.

Referring to factor F3, factor F3 can be a service level agreement (SLA) compliance factor. Configured software applications configured with use of user interface 3102 can include associated SLA parameters that must be complied with. Example SLA parameters can include parameters such as installation startup time, discussed in reference to factor F1, and availably discussed in reference to factor F2. Cluster manager 110 can scale scoring values under factor F3 in dependence on a degree of compliance with one or more SLA parameter associated to an application, and can assign a disqualifying negative scoring value under factor F3 where the evaluated deployment arrangement does not satisfy an SLA parameter.

Referring to factor F4 of Eq. 1, cluster manager 110 can assign scoring values under factor F4 in dependence on a determined similarity between the current application for which deployment has been requested and one or more application that is currently deployed on an integration runtime engine being evaluated using Eq. 1 for assigning and scaling scoring values under factor F4. Cluster manager 110 once again can employ a clustering analysis that is described in reference to the clustering analysis diagram of FIG. 5.

In one embodiment, cluster manager 110 scaling scoring values under factor F4 can include cluster manager 110 scaling scoring values in dependence on a determined Euclidean distance of the current application for which deployment has been requested in reference to the aggregate Euclidean distance of the current application for which deployment is requested and all applications currently running on an integration runtime engine being evaluated. In one scenario, datapoint 5102 at location A can represent the application.

A single application currently running on an integration runtime engine being evaluated and the data point 5104 can represent a new application for which deployment was requested. In such a scenario, cluster manager 110 can assign a high, e.g., approaching 1.0 scoring value representing the small Euclidean distance between datapoint 5104 and datapoint 5102 at location A.

In another scenario, the current application once again can be represented by datapoint 5104 and the currently running application running on integration runtime engine can include the application represented by datapoint 5102 at location B and the application represented by datapoint 5102 at location C. In such a situation, given the significant aggregate Euclidean distance between datapoint 5104 and datapoint 5102 at location B aggregated with the large Euclidean distance between datapoint 5104 and the datapoint 5102 at location C, cluster manager 110 can assign scoring value under factor F3 of less than 0.5 indicating a lesser degree of application compatibility than is described in reference to the first scenario where the current application is represented by datapoint 5104 and the single currently running application running on the integration runtime engine being evaluated is the datapoint 5102 at location A. In reference to the application clustering diagram of FIG. 5 applications can be compared across multiple dimensions, e.g., task type and task strength, e.g., as measured by number of lines of code. Another dimension for comparing applications can be application complexity, which can be measured, e.g., by number of tasks and or aggregated number of lines of code. In FIG. 5, only first and second dimensions are represented. However, it will be understood that clustering analysis can be scaled, e.g., to N dimensions.

Referring to factor F5, factor F5 can be an integration runtime engine compatibility factor. Cluster manager 110 assigning scaling scoring values under factor F5 can include cluster manager 110 scaling scoring values under factor F5 in dependence on the similarity between a designated integration runtime engine designed for supporting a current application for deployment, and b) integration runtime engine currently being evaluated for suitability with use of Eq. 1.

Cluster manager 110 can employ clustering analysis for ascertaining similarity based scoring values assigned under factor F5. As noted in reference to FIG. 3, a user can specify a certainly provisioned integration runtime engine for supporting a particular application. However, embodiments herein recognize that advantages can be derived by supporting a new application instead on a different and currently running integration runtime engine. Further, in one possible embodiment herein, cluster manager 110 may make available one or more “stock” integration runtime engines that are suitable for supporting a wide variety of applications.

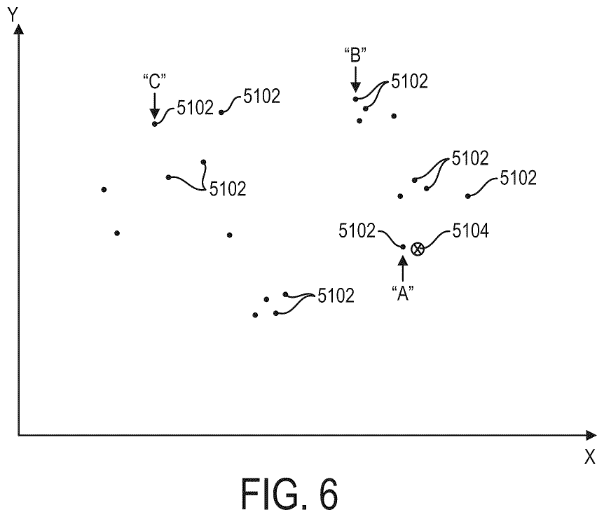

With reference to the clustering analysis diagram of FIG. 6, data points 6102 represent dimensions of integration runtime engines currently running within cluster 106 and data point 6104 represents dimensions of a configured integration runtime engine configured for supporting of the current application for which deployment has been requested. In reference to FIG. 4, a user can configure an integration runtime engine specifically for supporting a currently configured software application. Embodiments herein, however, can evaluate the application being deployed to a currently running integration runtime engine.

In one scenario, data point 6102 can represent dimensions of the integration runtime engine IRE A, the data point 6102 at location B can represent the integration runtime engine IRE B as set forth in FIG. 2, and the data point 6102 at location C can represent integration runtime engine IRE C as set forth in FIG. 2. In such a scenario, cluster manager 110 can assign highest scoring value, e.g., approaching 1.0 under factor F3 when evaluating the integration runtime engine IRE C under factor F4 based on the integration runtime engine IRC having the smallest Euclidean distance with reference to data point 6104 relative to the alternative candidate data points at locations A and C.

In the clustering analysis diagram of FIG. 6, first and second dimensions for characterizing integration runtime engines are described. The different dimensions can include, e.g., numbers of virtual machines, CPU allocation for the virtual machines, working memory for the allocated virtual machines, allocated storage memory for the allocated virtual machines and the like. While only first and second dimensions are shown in the clustering analysis diagram of FIG. 6, the number dimensions can be scaled, e.g., to N dimensions.

At action decision block 1108, cluster manager 110 can return a deployment action decision for deployment of the current application for which application deployment has been requested in dependence on the examining at block 1107, including in dependence on the scoring of various alternative integration runtime engines evaluated using Eq. 1.

Cluster manager 110 at block 1108, can return an action decision to deploy the application currently requested for deployment in dependence on an ordered ranking of evaluated integration runtime engines that have been evaluated using Eq. 1. At block 1108, cluster manager 110 can generate an ordered list of evaluated integration runtime engines that have been based on the scoring values applied using Eq. 2 and can deploy and return an action decision to deploy the application currently requested for deployment to the highest ranking integration runtime engine.

Table D depicts an illustrative result of cluster manager 110 evaluating an application for which deployment is requested.

TABLE D

| Row | IRE | Score (Eq. 1) |
|---|---|---|
| 1 | IRE A | <−998 |
| 2 | IRE B | 0.861 |
| 3 | IRE C | <−998 |
| 4 | IRE D | 0.401 |
| 5 | IRE E | 0.711 |

In the depicted scenario of Table D, cluster manager 110 can evaluate a configured software application for deployment on the candidate running integration runtime engines IRE A, IRE B, IRE C, IRE D, and IRE E, using Eq. 1. Cluster manager 110 can disqualify IRE A and IRE C based on the availability and/or SLA factor driving the candidate integration runtime engine to a disqualifying low number. Cluster manager 110 can order the remaining evaluated integration runtime engines according to an ordered list and can select IRE B as the integration runtime for supporting the application for which deployment has been requested.

On completion of action decision block 1108, cluster manager 110 can proceed to send block 1109. At send block 1109, cluster manager 110 can send provisioning data to a cluster in accordance with the action decision returned at block 1108 in order to install required application defining resources for deployment to the selected integration runtime engine.

In some use cases, none of the integration runtime engines subject to examining at block 1107 can be deemed suitable for supporting the current application, in which case cluster manager 110 at action decision block 1108 can return the action decision to deploy and instantiate a new integration runtime engine for supporting the application for which deployment has been requested. In such a scenario, cluster manager 110 at send block 1109 can send provisioning data for instantiation of the new integration runtime engine which can be an integration runtime engine configured contemporaneously by an administrator user with use of user interface 3102 of FIG. 3 when configuring the application for deployment. In response to the provisioning data sent at block 1109, cluster 106 can perform specified installations in accordance with the provisioning data at install block 1063.

When an application is deployed to a certain integration runtime engine at send block 1109 and ensuing install block 1063, one or more program defining at least one application supporting resource of an integration runtime engine and one or more programs can be in communication with one another. In one embodiment, an application supporting resource of an integration runtime engine and/or an application can be containerized and container storing program data of an integration runtime engine and program data of an application can be in communication with one another on deployment of an application to an integration runtime engine. In one embodiment, when an application is deployed to a certain integration runtime engine at send block 1109 and ensuing install block 1063, one or more program defining at least one application supporting resource of an integration runtime engine and one or more program can be installed on a common host, e.g., a common computing node of computing nodes 10A-10Z as set forth in FIG. 2, or a common hypervisor based virtual machine VM, also as set forth in FIG. 2.

On completion of block 1109, cluster manager 110 can proceed to recording block 1110. At recording block 1110, cluster manager 110 can record information of the deployment initiated at block 1109, e.g., can record information, specifying which integration runtime engine the application requested for deployment has been deployed to, the application loading of such integration runtime, and metrics of such integration runtime. On completion of recording block 1110, cluster manager 110 can proceed to return block 1111. At return block 1111, cluster manager 110 can return to a stage preceding block 1101 to receive additional application data sent at send block 1401 and can iteratively perform the loop of blocks 1101-1111 for a deployment period of cluster manager.

Enterprise systems 140A-140Z can iteratively perform the loop of blocks 1401-1402 for a deployment period of enterprise systems 140A-140Z. UE devices 130A-130Z can iteratively be performing the loop of blocks 1301-1303 for a deployment period of UE devices 130A-130Z. Cluster 106 can iteratively be performing the loop of blocks 1061-1064 for a deployment period of cluster. Clients 150A-150Z can iteratively be performing the loop of blocks 1501-1502 for a deployment period of clients 150A-150Z.

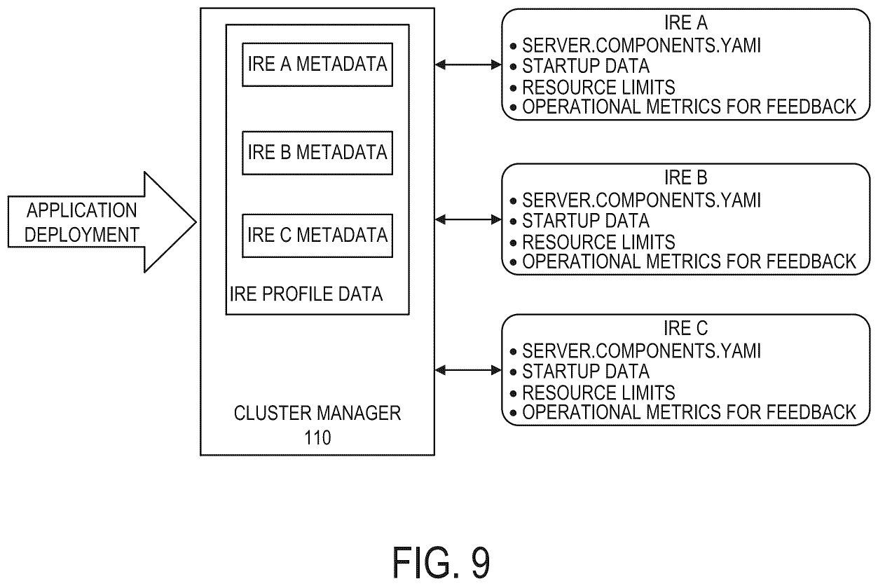

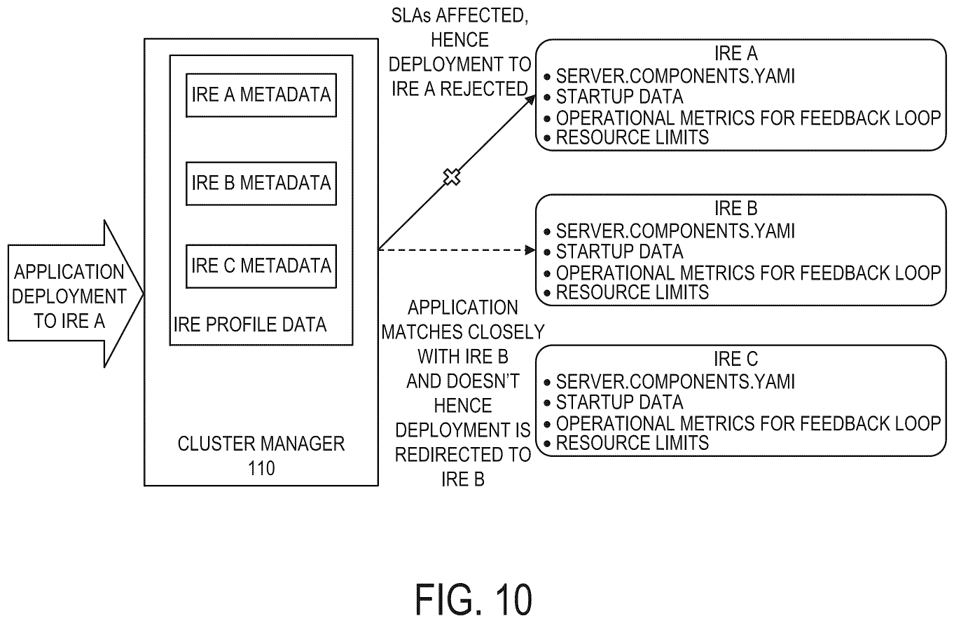

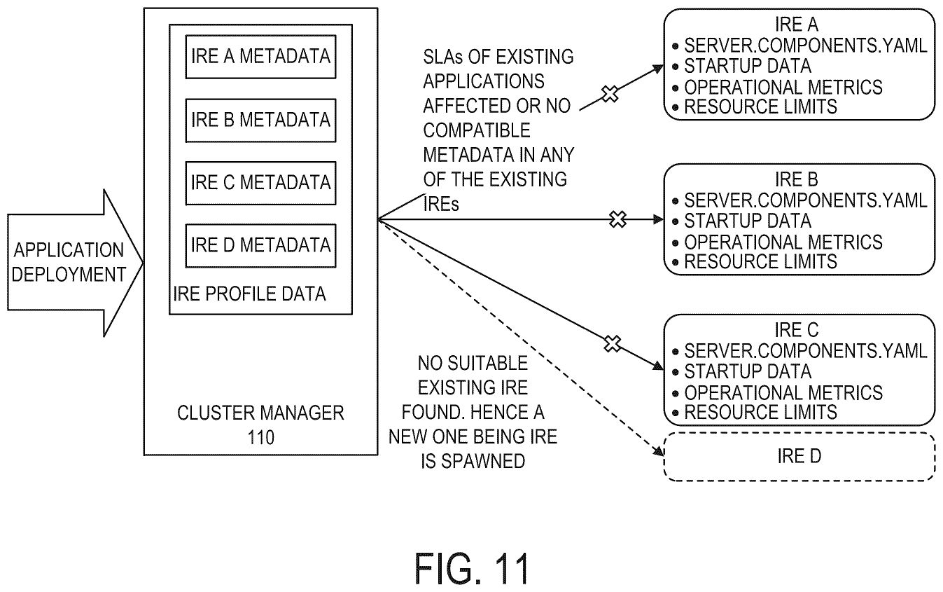

Further examples are set forth in reference to FIGS. 9-11. In reference to FIG. 9, cluster manager 110 can examine application configuration data and profile data that specifies attributes of a plurality of integration runtime engines. As depicted in FIG. 10, cluster manager 110 can select for deployment of an application an integration runtime engine having a high degree of compatibility with an application and can disqualify certain integration runtime engines from supporting the application. As depicted in FIG. 11, cluster manager 110 can spawn a new integration runtime conditionally on the condition that there are no qualifying integration runtime engines.

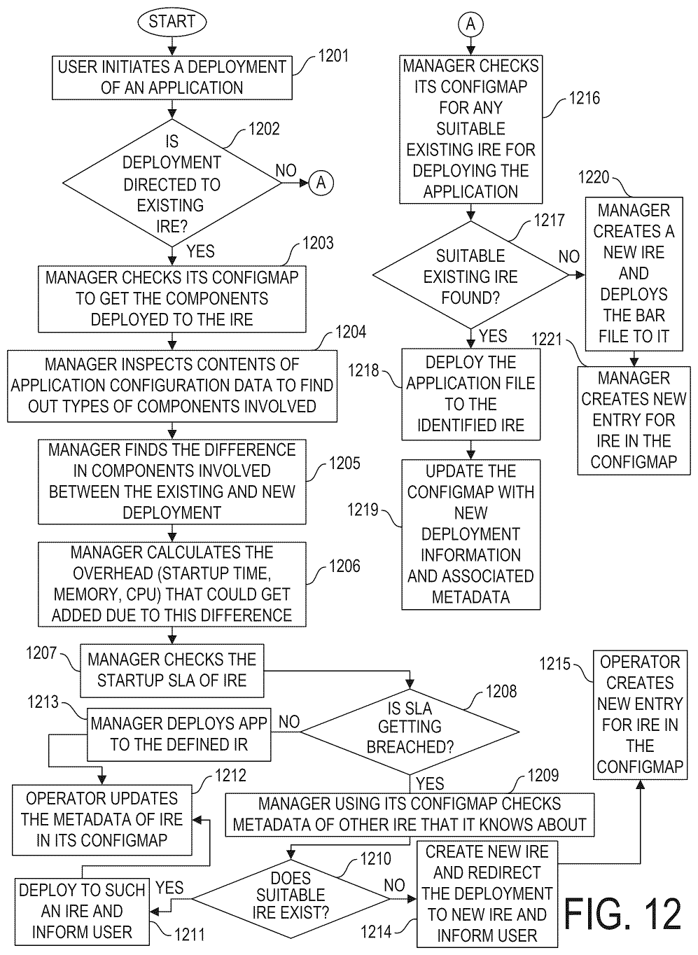

Referring to FIG. 12, cluster manager 110 in executing blocks 1201-1222 can evaluate a plurality of integration runtime engines for supporting a configured software application. Cluster manager 110 can disqualify one or more integration runtime engine based on an SLA requirement not being satisfied. Cluster manager 110 can select for supporting the application a candidate integration runtime engine having a high degree of compatibility with the configured software application. Cluster manager 110 can spawn a new integration runtime engine responsively to determining that no currently running integration engine is qualified for supporting the configured software application.

Table E summarizes various scenarios.

TABLE E

| Scenario | Cluster manager assessment | Example action(s) |
|---|---|---|
| Deployment requested for | New configured software | Cluster manager 110 identifies a |
| configured software application | application will negatively | better suited IRE and deploys |
| with targeted running IRE | impact target IRE's SLA(s) | the application there |
| specified | (configured software application | Or |
| | SLA > existing IRE) | Cluster manager 110 spawns |
| | | new IRE if no suitable existing |
| | | IRE is found |
| | | Or |
| | | Cluster manager 110 rejects the |
| | | deployment if a new IRE cannot |
| | | be created |
| Deployment requested for | New configured software | Cluster manager 110 deploys the |
| configured software application | application will not negatively | configured software application |
| with targeted running IRE | impact target IRE's SLA(s) | to target IRE |
| specified | (configured software application | |
| | SLA <= existing IRE) | |
| Deployment requested for | No suitable existing IRE to | Cluster manager 110 spawns |
| configured software application | support configured software | new IRE and deploys configured |
| without targeted running IRE | application without impacting | software application to new IRE |
| specified | IRE's SLAS | |

Various available tools, libraries, and/or services can be utilized for implementation of trained predictive models herein trained by machine learning, such as predictive model 4502, and/or predictive model 7502. For example, a machine learning service can provide access to libraries and executable code for support of machine learning functions. A machine learning service can provide access to a set of REST APIs that can be called from any programming language and that permit the integration of predictive analytics into any application. Enabled REST APIs can provide e.g., retrieval of metadata for a given predictive model, deployment of models and management of deployed models, online deployment, scoring, batch deployment, stream deployment, monitoring and retraining deployed models. According to one possible implementation, a machine learning service can provide access to a set of REST APIs that can be called from any programming language and that permit the integration of predictive analytics into any application. Enabled REST APIs can provide, e.g., retrieval of metadata for a given predictive model, deployment of models and management of deployed models, online deployment, scoring, batch deployment, stream deployment, monitoring and retraining deployed models. Trained predictive models herein can employ use, e.g., of artificial neural networks (ANNs) support vector machines (SVM), Bayesian networks, and/or other machine learning technologies.

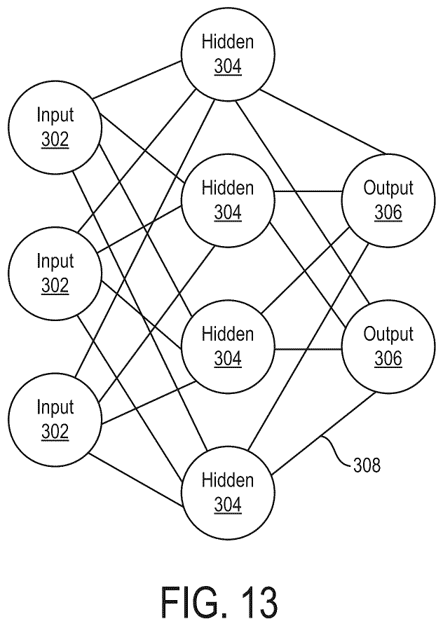

FIG. 13 is an illustration of an example ANN architecture for trained predictive models herein trained by machine learning, such as predictive model 4502, and/or predictive model 7502.

One element of ANNs is the structure of the information processing system, which includes a large number of highly interconnected processing elements (called “neurons”) working in parallel to solve specific problems. ANNs are furthermore trained using a set of training data, with learning that involves adjustments to weights that exist between the neurons. An ANN is configured for a specific application, such the applications discussed in connection with predictive model 4502, and/or predictive model 7502.

Referring now to FIG. 13, a generalized diagram of a neural network is shown. Although a specific structure of an ANN is shown, having three layers and a set number of fully connected neurons, it should be understood that this is intended solely for the purpose of illustration. In practice, the present embodiments may take any appropriate form, including any number of layers and any pattern or patterns of connections therebetween.

ANNs demonstrate an ability to derive meaning from complicated or imprecise data and can be used to extract patterns and detect trends that are too complex to be detected by humans or other computer-based systems. The structure of a neural network is known generally to have input neurons 302 that provide information to one or more “hidden” neurons 304. Connections 308 between the input neurons 302 and hidden neurons 304 are weighted, and these weighted inputs are then processed by the hidden neurons 304 according to some function in the hidden neurons 304. There can be any number of layers of hidden neurons 304, and as well as neurons that perform different functions. There exist different neural network structures as well, such as a convolutional neural network, a maxout network, etc., which may vary according to the structure and function of the hidden layers, as well as the pattern of weights between the layers. The individual layers may perform particular functions, and may include convolutional layers, pooling layers, fully connected layers, softmax layers, or any other appropriate type of neural network layer. Finally, a set of output neurons 306 accepts and processes weighted input from the last set of hidden neurons 304.

This represents a “feed-forward” computation, where information propagates from input neurons 302 to the output neurons 306. Upon completion of a feed-forward computation, the output is compared to a desired output available from training data. The error relative to the training data is then processed in “backpropagation” computation, where the hidden neurons 304 and input neurons 302 receive information regarding the error propagating backward from the output neurons 306. Once the backward error propagation has been completed, weight updates are performed, with the weighted connections 308 being updated to account for the received error. It should be noted that the three modes of operation, feed forward, back propagation, and weight update, do not overlap with one another. This represents just one variety of ANN computation, and that any appropriate form of computation may be used instead.

To train an ANN, training data can be divided into a training set and a testing set. The training data includes pairs of an input and a known output, which can be referred to as outcome training data as referenced in connection with predictive models 4502 and 7502 herein. During training, the inputs of the training set are fed into the ANN using feed-forward propagation. After each input, the output of the ANN is compared to the respective known output. Discrepancies between the output of the ANN and the known output that is associated with that particular input are used to generate an error value, which may be backpropagated through the ANN, after which the weight values of the ANN may be updated. This process can continue until the pairs in the training set are exhausted.

After the training has been completed, the ANN may be tested against the testing set, to ensure that the training has not resulted in overfitting. If the ANN can generalize to new inputs, beyond those which it was already trained on, then it is ready for use. If the ANN does not accurately reproduce the known outputs of the testing set, then additional training data may be needed, or hyperparameters of the ANN may need to be adjusted.

ANNs may be implemented in software, hardware, or a combination of the two. For example, each weighted connection of weighted connections 308 may be characterized as a weight value that is stored in a computer memory, and the activation function of each neuron may be implemented by a computer processor. The weight value may store any appropriate data value, such as a real number, a binary value, or a value selected from a fixed number of possibilities, that is multiplied against the relevant neuron outputs. Alternatively, the weighted connections 308 may be implemented as resistive processing units (RPUs), generating a predictable current output when an input voltage is applied in accordance with a settable resistance.

Certain embodiments herein may offer various technical computing advantages involving computing advantages to address problems arising in the realm of computer systems. Embodiments herein recognize that it can be useful for an enterprise when configuring an application to also configure an integration runtime engine for supporting running of an application. The configured integration runtime engine can include certain computing resources, which can be defined by container-based virtual machines (containers). The configured integration runtime engine can include one or more application supporting resource for supporting an application. The one or more application supporting resource can be containerized in some embodiments. Embodiments herein also recognize that efficiencies in computing computer resource the utilization can be yielded by deploying an application to previously a deployed and currently running integration runtime engine. Embodiments herein include features so that a newly configured software application can be deployed to a previously deployed currently running integration runtime engine. In one use case, the previously deployed concurrently running integration runtime engine can include one or more application supporting resource that can support the running of the newly deployed application. Thus, deploying an application to an integration runtime engine that is currently running can avoid deployment and installation of the application supporting resource. Embodiments herein can examine data from diverse data sources for return of action decisions. Embodiments herein can include artificial intelligence processing platforms featuring improved processes to transform unstructured data into structured form permitting computer-based analytics and decision making. Embodiments herein can include particular arrangements for both collecting rich data into a data repository and additional particular arrangements for updating such data and for use of that data to drive artificial intelligence decision making. By leveraging data structures to organize relationships, the techniques described herein can increase efficiency in locating relevant content that can be extracted for presentment to interfaces described herein. Certain embodiments may be implemented by use of a cloud platform/data center in various types including a Software-as-a-Service (SaaS), Platform-as-a-Service (PaaS), Database-as-a-Service (DBaaS), and combinations thereof based on types of subscription.

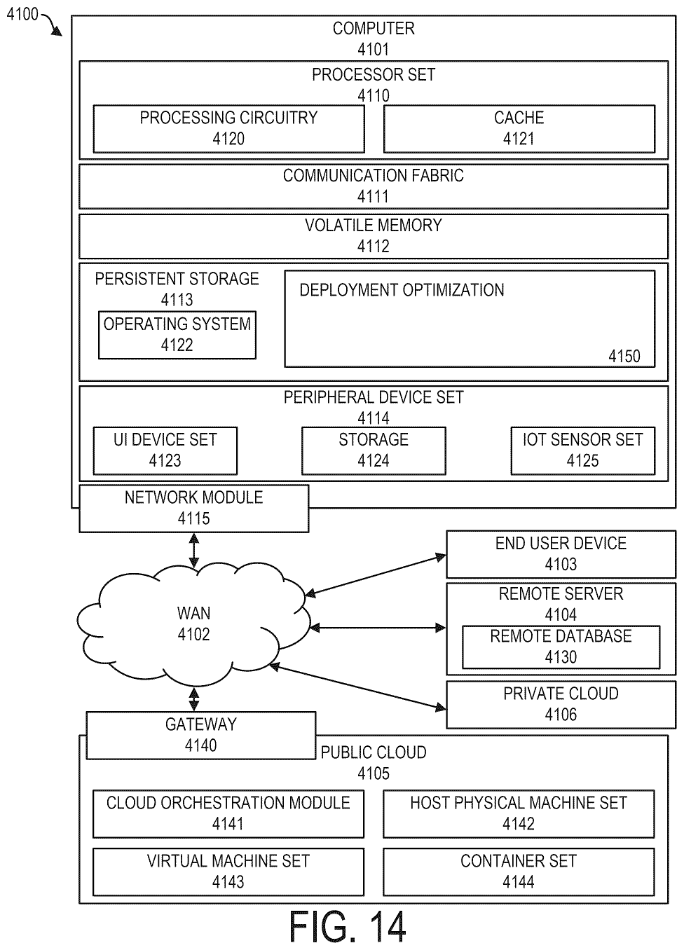

In reference to FIG. 14 there is set forth a description of a computing environment 4100 that can include one or more computer 4101. In one example, respective computing nodes 10A-10Z as set forth herein can be provided in accordance with computer 4101 as set forth in FIG. 14.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

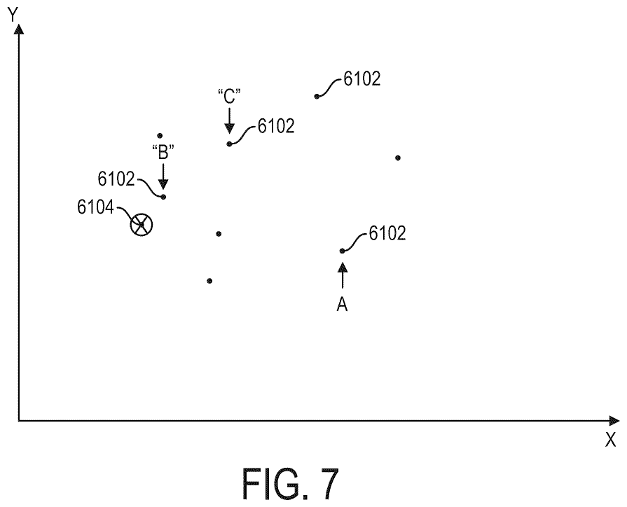

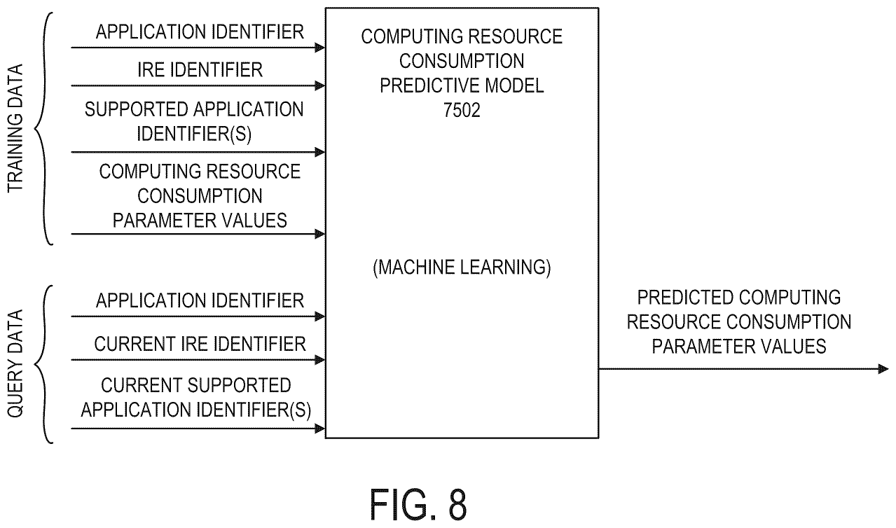

One example of a computing environment to perform, incorporate and/or use one or more aspects of the present invention is described with reference to FIG. 14. In one aspect, a computing environment 4100 contains an example of an environment for the execution of at least some of the computer code involved in performing the inventive methods, such as code 4150 for performing deployment optimization described with reference to FIGS. 1-13. In addition to block 4150, computing environment 4100 includes, for example, computer 4101, wide area network (WAN) 4102, end user device (EUD) 4103, remote server 4104, public cloud 4105, and private cloud 4106. In this embodiment, computer 4101 includes processor set 4110 (including processing circuitry 4120 and cache 4121), communication fabric 4111, volatile memory 4112, persistent storage 4113 (including operating system 4122 and block 4150, as identified above), peripheral device set 4114 (including user interface (UI) device set 4123, storage 4124, and Internet of Things (IoT) sensor set 4125), and network module 4115. Remote server 4104 includes remote database 4130. Public cloud 4105 includes gateway 4140, cloud orchestration module 4141, host physical machine set 4142, virtual machine set 4143, and container set 4144. IoT sensor set 4125, in one example, can include a Global Positioning Sensor (GPS) device, one or more of a camera, a gyroscope, a temperature sensor, a motion sensor, a humidity sensor, a pulse sensor, a blood pressure (bp) sensor or an audio input device.

Computer 4101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 4130. As is well understood in the art of computer technology, and depending upon the technology, performance of a computer-implemented method may be distributed among multiple computers and/or between multiple locations. On the other hand, in this presentation of computing environment 4100, detailed discussion is focused on a single computer, specifically computer 4101, to keep the presentation as simple as possible. Computer 4101 may be located in a cloud, even though it is not shown in a cloud in FIG. 1. On the other hand, computer 4101 is not required to be in a cloud except to any extent as may be affirmatively indicated.

Processor set 4110 includes one, or more, computer processors of any type now known or to be developed in the future. Processing circuitry 4120 may be distributed over multiple packages, for example, multiple, coordinated integrated circuit chips. Processing circuitry 4120 may implement multiple processor threads and/or multiple processor cores. Cache 4121 is memory that is located in the processor chip package(s) and is typically used for data or code that should be available for rapid access by the threads or cores running on processor set 4110. Cache memories are typically organized into multiple levels depending upon relative proximity to the processing circuitry. Alternatively, some, or all, of the cache for the processor set may be located “off chip.” In some computing environments, processor set 4110 may be designed for working with qubits and performing quantum computing.

Computer readable program instructions are typically loaded onto computer 4101 to cause a series of operational steps to be performed by processor set 4110 of computer 4101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 4121 and the other storage media discussed below. The program instructions, and associated data, are accessed by processor set 4110 to control and direct performance of the inventive methods. In computing environment 4100, at least some of the instructions for performing the inventive methods may be stored in block 4150 in persistent storage 4113.

Communication fabric 4111 is the signal conduction paths that allow the various components of computer 4101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 4112 is any type of volatile memory now known or to be developed in the future. Examples include dynamic type random access memory (RAM) or static type RAM. Typically, the volatile memory is characterized by random access, but this is not required unless affirmatively indicated. In computer 4101, the volatile memory 4112 is located in a single package and is internal to computer 4101, but, alternatively or additionally, the volatile memory may be distributed over multiple packages and/or located externally with respect to computer 4101.

Persistent storage 4113 is any form of non-volatile storage for computers that is now known or to be developed in the future. The non-volatility of this storage means that the stored data is maintained regardless of whether power is being supplied to computer 4101 and/or directly to persistent storage 4113. Persistent storage 4113 may be a read only memory (ROM), but typically at least a portion of the persistent storage allows writing of data, deletion of data and re-writing of data. Some familiar forms of persistent storage include magnetic disks and solid-state storage devices. Operating system 4122 may take several forms, such as various known proprietary operating systems or open source. Portable Operating System Interface-type operating systems that employ a kernel. The code included in block 4150 typically includes at least some of the computer code involved in performing the inventive methods.

Peripheral device set 4114 includes the set of peripheral devices of computer 4101. Data communication connections between the peripheral devices and the other components of computer 4101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 4123 may include components such as a display screen, speaker, microphone, wearable devices (such as goggles and smart watches), keyboard, mouse, printer, touchpad, game controllers, and haptic devices. Storage 4124 is external storage, such as an external hard drive, or insertable storage, such as an SD card. Storage 4124 may be persistent and/or volatile. In some embodiments, storage 4124 may take the form of a quantum computing storage device for storing data in the form of qubits. In embodiments where computer 4101 is required to have a large amount of storage (for example, where computer 4101 locally stores and manages a large database) then this storage may be provided by peripheral storage devices designed for storing very large amounts of data, such as a storage area network (SAN) that is shared by multiple, geographically distributed computers. IoT sensor set 4125 is made up of sensors that can be used in Internet of Things applications. For example, one sensor may be a thermometer and another sensor may be a motion detector. A sensor of IoT sensor set 4125 can alternatively or in addition include, e.g., one or more of a camera, a gyroscope, a humidity sensor, a pulse sensor, a blood pressure (bp) sensor or an audio input device.

Network module 4115 is the collection of computer software, hardware, and firmware that allows computer 4101 to communicate with other computers through WAN 4102. Network module 4115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 4115 are performed on the same physical hardware device. In other embodiments (for example, embodiments that utilize software-defined networking (SDN)), the control functions and the forwarding functions of network module 4115 are performed on physically separate devices, such that the control functions manage several different network hardware devices. Computer readable program instructions for performing the inventive methods can typically be downloaded to computer 4101 from an external computer or external storage device through a network adapter card or network interface included in network module 4115.

WAN 4102 is any wide area network (for example, the internet) capable of communicating computer data over non-local distances by any technology for communicating computer data, now known or to be developed in the future. In some embodiments, the WAN 4102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 4103 is any computer system that is used and controlled by an end user (for example, a customer of an enterprise that operates computer 4101), and may take any of the forms discussed above in connection with computer 4101. EUD 4103 typically receives helpful and useful data from the operations of computer 4101. For example, in a hypothetical case where computer 4101 is designed to provide a recommendation to an end user, this recommendation would typically be communicated from network module 4115 of computer 4101 through WAN 4102 to EUD 4103. In this way, EUD 4103 can display, or otherwise present, the recommendation to an end user. In some embodiments, EUD 4103 may be a client device, such as thin client, heavy client, mainframe computer, desktop computer and so on.

Remote server 4104 is any computer system that serves at least some data and/or functionality to computer 4101. Remote server 4104 may be controlled and used by the same entity that operates computer 4101. Remote server 4104 represents the machine(s) that collect and store helpful and useful data for use by other computers, such as computer 4101. For example, in a hypothetical case where computer 4101 is designed and programmed to provide a recommendation based on historical data, then this historical data may be provided to computer 4101 from remote database 4130 of remote server 4104.

Public cloud 4105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 4105 is performed by the computer hardware and/or software of cloud orchestration module 4141. The computing resources provided by public cloud 4105 are typically implemented by virtual computing environments that run on various computers making up the computers of host physical machine set 4142, which is the universe of physical computers in and/or available to public cloud 4105. The virtual computing environments (VCEs) typically take the form of virtual machines from virtual machine set 4143 and/or containers from container set 4144. It is understood that these VCEs may be stored as images and may be transferred among and between the various physical machine hosts, either as images or after instantiation of the VCE. Cloud orchestration module 4141 manages the transfer and storage of images, deploys new instantiations of VCEs and manages active instantiations of VCE deployments. Gateway 4140 is the collection of computer software, hardware, and firmware that allows public cloud 4105 to communicate through WAN 4102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 4106 is similar to public cloud 4105, except that the computing resources are only available for use by a single enterprise. While private cloud 4106 is depicted as being in communication with WAN 4102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 4105 and private cloud 4106 are both part of a larger hybrid cloud.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

The terminology used herein is for the purpose of describing particular embodiments only and is not intended to be limiting. As used herein, the singular forms “a,” “an,” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and “containing”) are open-ended linking verbs. As a result, a method or device that “comprises,” “has,” “includes,” or “contains” one or more steps or elements possesses those one or more steps or elements but is not limited to possessing only those one or more steps or elements. Likewise, a step of a method or an element of a device that “comprises,” “has,” “includes,” or “contains” one or more features possesses those one or more features but is not limited to possessing only those one or more features. Forms of the term “based on” herein encompass relationships where an element is partially based on as well as relationships where an element is entirely based on. Methods, products and systems described as having a certain number of elements can be practiced with less than or greater than the certain number of elements. Furthermore, a device or structure that is configured in a certain way is configured in at least that way but may also be configured in ways that are not listed.

It is contemplated that numerical values, as well as other values that are recited herein are modified by the term “about”, whether expressly stated or inherently derived by the discussion of the present disclosure. As used herein, the term “about” defines the numerical boundaries of the modified values so as to include, but not be limited to, tolerances and values up to, and including the numerical value so modified. That is, numerical values can include the actual value that is expressly stated, as well as other values that are, or can be, the decimal, fractional, or other multiple of the actual value indicated, and/or described in the disclosure.

The corresponding structures, materials, acts, and equivalents of all means or step plus function elements in the claims below, if any, are intended to include any structure, material, or act for performing the function in combination with other claimed elements as specifically claimed. The description set forth herein has been presented for purposes of illustration and description but is not intended to be exhaustive or limited to the form disclosed. Many modifications and variations will be apparent to those of ordinary skill in the art without departing from the scope and spirit of the disclosure. The embodiment was chosen and described in order to best explain the principles of one or more aspects set forth herein and the practical application, and to enable others of ordinary skill in the art to understand one or more aspects as described herein for various embodiments with various modifications as are suited to the particular use contemplated.

What is claimed is:

1. A computer implemented method comprising:
examining application configuration data defining a configured software application and integration runtime engine profile data that specifies attributes of a plurality of integration runtime engines currently running within a computer environment;
evaluating, in dependence on the examining, a suitability of respective ones of the plurality of the integration runtime engines for supporting running of the configured software application;
returning an action decision in dependence on the evaluating, wherein the action decision specifies a selected integration runtime engine for supporting running of the configured software application; and
deploying the configured software application to the selected integration runtime engine.

2. The computer implemented method of claim 1, wherein the application configuration data has been defined by an administrator user with use of a user interface.

3. The computer implemented method of claim 1, wherein the evaluating includes evaluating whether a service level agreement (SLA) requirement will be satisfied.

4. The computer implemented method of claim 1, wherein the evaluating includes predicting availability of the respective ones of the plurality of integration runtime engines with the configured software application deployed thereto.

5. The computer implemented method of claim 1, wherein the evaluating includes predicting a deployment latency of the configured software application on deployment to respective ones of the plurality of integration runtime engines.

6. The computer implemented method of claim 1, wherein the evaluating includes applying a plurality of factors.

7. The computer implemented method of claim 1, wherein the plurality of integration runtime engines currently running within a computer environment include a targeted integration runtime engine selected by an administrator user and at least one additional integration runtime engine, wherein the action decision specifies an additional integration runtime engine of the at least one additional integration runtime engine as the selected integration runtime engine.

8. The computer implemented method of claim 1, wherein the method includes spawning the selected integration runtime engine responsively to the action decision.

9. The computer implemented method of claim 1, wherein the method includes spawning the selected integration runtime engine responsively to the action decision and deploying the configured software application to the responsively spawned selected integration runtime engine.

10. The computer implemented method of claim 1, wherein the evaluating includes predicting a deployment latency of the configured software application on deployment to respective ones of the plurality of integration runtime engines, wherein the predicting the deployment latency includes querying a predictive model that has been trained with iterations of training data, wherein the iterations of training data include data specifying historical deployments of the respective ones of the plurality of integration runtime engines.

11. The computer implemented method of claim 1, wherein the evaluating includes predicting a deployment latency of the configured software application on deployment to respective ones of the plurality of integration runtime engines, wherein the predicting the deployment latency includes querying a predictive model that has been trained with iterations of training data, wherein the iterations of training data include data specifying historical deployments of the respective ones of the plurality of integration runtime engines as well as application loading conditions of the respective ones of the plurality of integration runtime engines during the historical deployments of the respective ones of the plurality of integration runtime engines.

12. The computer implemented method of claim 1, wherein the evaluating includes predicting a deployment latency of the configured software application on deployment to respective ones of the plurality of integration runtime engines, wherein the predicting the deployment latency includes querying a predictive model that has been trained with iterations of training data, wherein the iterations of training data include data specifying historical deployments of the respective ones of the plurality of integration runtime engines as well as application loading conditions of the respective ones of the plurality of integration runtime engines during the historical deployments of the respective ones of the plurality of integration runtime engines, and wherein the querying the predictive model includes querying the predictive model with an application identifier of an historical application determined to be similar to the configured software application via clustering analysis.

13. The computer implemented method of claim 1, wherein the evaluating includes predicting availability of the respective ones of the plurality of integration runtime engines with the configured software application deployed thereto, wherein the predicting the availability of the respective ones of the plurality of integration runtime engines with the configured software application deployed thereto includes querying a machine learning predictive model that has been trained with multiple iterations of training data, wherein the multiple iterations of training data include data specifying prior historical deployments of the respective ones of the plurality of integration runtime engines.

14. The computer implemented method of claim 1, wherein the evaluating includes predicting availability of the respective ones of the plurality of integration runtime engines with the configured software application deployed thereto, wherein the predicting the availability of the respective ones of the plurality of integration runtime engines with the configured software application deployed thereto includes querying a machine learning predictive model that has been trained with multiple iterations of training data, wherein the multiple iterations of training data include data specifying prior historical deployments of the respective ones of the plurality of integration runtime engines as well as deployed application loading conditions of the respective ones of the plurality of integration runtime engines during the prior historical deployments of the respective ones of the plurality of integration runtime engines.

15. The computer implemented method of claim 1, wherein the evaluating includes predicting a deployment latency of the configured software application on deployment to respective ones of the plurality of integration runtime engines, wherein the predicting the deployment latency includes querying a predictive model that has been trained with iterations of training data, wherein the iterations of training data include data specifying historical deployments of the respective ones of the plurality of integration runtime engines, wherein the evaluating includes predicting availability of the respective ones of the plurality of integration runtime engines with the configured software application deployed thereto, wherein the predicting the availability of the respective ones of the plurality of integration runtime engines with the configured software application deployed thereto includes querying a machine learning predictive model that has been trained with multiple iterations of training data, wherein the multiple iterations of training data include data specifying prior historical deployments of the respective ones of the plurality of integration runtime engines.

16. The computer implemented method of claim 1, wherein the evaluating includes predicting a deployment latency of the configured software application on deployment to respective ones of the plurality of integration runtime engines, wherein the predicting the deployment latency includes querying a predictive model that has been trained with iterations of training data, wherein the iterations of training data include data specifying historical deployments of the respective ones of the plurality of integration runtime engines, wherein the evaluating includes predicting availability of the respective ones of the plurality of integration runtime engines with the configured software application deployed thereto, wherein the predicting the availability of the respective ones of the plurality of integration runtime engines with the configured software application deployed thereto includes querying a machine learning predictive model that has been trained with multiple iterations of training data, wherein the multiple iterations of training data include data specifying prior historical deployments of the respective ones of the plurality of integration runtime engines, and wherein the evaluating includes evaluating whether a service level agreement (SLA) requirement will be satisfied.

17. The computer implemented method of claim 1, wherein the evaluating includes predicting a deployment latency of the configured software application on deployment to respective ones of the plurality of integration runtime engines, wherein the predicting the deployment latency includes querying a predictive model that has been trained with iterations of training data, wherein the iterations of training data include data specifying historical deployments of the respective ones of the plurality of integration runtime engines as well as application loading conditions of the respective ones of the plurality of integration runtime engines during the historical deployments of the respective ones of the plurality of integration runtime engines, and wherein the querying the predictive model includes querying the predictive model with an application identifier of an historical application determined to be similar to the configured software application via clustering analysis, wherein the evaluating includes predicting a deployment latency of the configured software application on deployment to respective ones of the plurality of integration runtime engines, wherein the predicting the deployment latency includes querying a predictive model that has been trained with iterations of training data, wherein the iterations of training data include data specifying historical deployments of the respective ones of the plurality of integration runtime engines, wherein the evaluating includes predicting availability of the respective ones of the plurality of integration runtime engines with the configured software application deployed thereto, wherein the predicting the availability of the respective ones of the plurality of integration runtime engines with the configured software application deployed thereto includes querying a machine learning predictive model that has been trained with multiple iterations of training data, wherein the multiple iterations of training data include data specifying prior historical deployments of the respective ones of the plurality of integration runtime engines.

18. The computer implemented method of claim 1, wherein the evaluating includes predicting a deployment latency of the configured software application on deployment to respective ones of the plurality of integration runtime engines, wherein the predicting the deployment latency includes querying a predictive model that has been trained with iterations of training data, wherein the iterations of training data include data specifying historical deployments of the respective ones of the plurality of integration runtime engines as well as application loading conditions of the respective ones of the plurality of integration runtime engines during the historical deployments of the respective ones of the plurality of integration runtime engines, and wherein the querying the predictive model includes querying the predictive model with an application identifier of an historical application determined to be similar to the configured software application via clustering analysis, wherein the evaluating includes predicting a deployment latency of the configured software application on deployment to respective ones of the plurality of integration runtime engines, wherein the predicting the deployment latency includes querying a predictive model that has been trained with iterations of training data, wherein the iterations of training data include data specifying historical deployments of the respective ones of the plurality of integration runtime engines, wherein the evaluating includes biasing the predicted deployment latency in dependence on an order of execution between tasks, as defined by an administrator user using the user interface, wherein the evaluating includes predicting availability of the respective ones of the plurality of integration runtime engines with the configured software application deployed thereto, wherein the predicting the availability of the respective ones of the plurality of integration runtime engines with the configured software application deployed thereto includes querying a machine learning predictive model that has been trained with multiple iterations of training data, wherein the multiple iterations of training data include data specifying prior historical deployments of the respective ones of the plurality of integration runtime engines, wherein the application configuration data has been defined by an administrator user with use of a user interface, wherein the evaluating includes evaluating whether a service level agreement (SLA) requirement will be satisfied, wherein the plurality of integration runtime engines currently running within a computer environment include a targeted integration runtime engine selected by the administrator user and at least one additional integration runtime engine, wherein the action decision specifies an additional integration runtime engine of the at least one additional integration runtime engine as the selected integration runtime engine, and wherein the user interface permits the administrator user to designate any one of the following as the targeted integration runtime engine: (a) a newly configured integration runtime engine with computing resources including CPU working memory resources newly designated by the administrator user, (b) a currently running integrated runtime engine currently running within the computer environment, and (c) and historical integrated runtime engine that has been previously configured, but which is not currently running within the computer environment.

19. A system comprising:
a memory;
at least one processor in communication with the memory; and
program instructions executable by one or more processor via the memory to perform a method comprising:
examining application configuration data defining a configured software application and integration runtime engine profile data that specifies attributes of a plurality of integration runtime engines currently running within a computer environment;
evaluating, in dependence on the examining, a suitability of respective ones of the plurality of the integration runtime engines for supporting running of the configured software application;
returning an action decision in dependence on the evaluating, wherein the action decision specifies a selected integration runtime engine for supporting running of the configured software application; and
deploying the configured software application to the selected integration runtime engine.

20. A computer program product comprising:
a computer readable storage medium readable by one or more processing circuit and storing instructions for execution by one or more processor for performing a method comprising:
examining application configuration data defining a configured software application and integration runtime engine profile data that specifies attributes of a plurality of integration runtime engines currently running within a computer environment;
evaluating, in dependence on the examining, a suitability of respective ones of the plurality of the integration runtime engines for supporting running of the configured software application;
returning an action decision in dependence on the evaluating, wherein the action decision specifies a selected integration runtime engine for supporting running of the configured software application; and
deploying the configured software application to the selected integration runtime engine.
